(19) United States
(12) Patent Application Publication
(10) Pub. No.: US 2004/0240952 A1
(43) Pub. Date: Dec. 2, 2004

(54) Device for drilling holes in a ceiling

(76) Inventor: Eugene D. Perry, Mooresville, IN (US)

Correspondence Address: BARNES & THORNBURG, 11 SOUTH MERIDIAN, INDIANAPOLIS, IN, 46204

(21) Appl. No.: 10/802,444

(22) Filed: Mar. 17, 2004

Related U.S. Application Data
(60) Provisional application No. 60/455,702, filed on Mar. 18, 2003.

(51) Int. Cl. B23B 45/00

(52) U.S. Cl. 408/136

(57) ABSTRACT

A device for drilling holes in a ceiling is provided. The device has a base that is movable over a floor and positionable on a grid that aligns a drill or tool with desired hole positions on a ceiling. An actuator may move the tool relative to the ceiling.

The present invention relates aperture making devices, and more particularly to devices and methods for drilling a multitude of holes in a ceiling.

### BACKGROUND OF THE INVENTION

In construction work, particularly in the remodeling of existing buildings or in constructing of new buildings, it is required to anchor or attach a multitude of hangers or suspension members of some type from the concrete ceiling. While in the past, it has been a practice to shoot or drive anchors into such concrete ceilings, such activities have been curtailed at least in many government projects for safety reasons. Today, it is required to drill holes in the concrete ceiling and then to drive expansion anchors or other anchors into such holes. Typically, an anchor will be required for every sixteen square feet (a four feet by four feet square), but in high density hanger situations, an anchor may be required for every eight square feet of ceiling. Additional hangers may be required for additional lighting and other equipment.

### SUMMARY OF THE INVENTION

The present invention comprises one or more of the features recited in the attached claims or the following features or combinations thereof.

It is desirable to produce a hole or even a multitude of holes in a ceiling or similar overhead element. Often, in construction projects, such ceilings will be concrete or some material difficult to drill. In such a situation, a tool operator may be required to be placed in uncomfortable positions or even potentially harmful positions in an effort to produce the holes in the ceiling.

Typically, the grid layout for the ceiling anchors is laid out on the floor using a grid of longitudinally extending and transversely extending chalk lines. Directly above the intersections of such lines, the anchor points will be established. That is, vertically above each intersection on the floor, an anchor hole will be drilled in the ceiling.

Thus, an aperture making device is disclosed which allows a tool operator to remain on the floor and operate a tool actuator that moves the tool into and away from the hole-producing positions in the ceiling. The aperture making device comprises a tool configured for producing a hole, a tool support configured to support the tool above a floor, and a tool actuator configured to vertically move the tool relative to the tool support such that the tool can be placed in hole-producing range of the ceiling.

The tool support may comprise a base which is movable about on the floor to locate the intersections of the chalk lines. The base may have caster wheels for facilitating easy movement of the base about the floor. Such a base may comprise four legs with a caster at the distal end of each of the four legs. With the four legs in a cross pattern, the legs will define a central portion of the base. Thus, the tool support may comprise a base having an elongated member extending vertically upwardly from the central portion of the base. This elongated member may be any type of structural member such as, for example, a square steel tube. Support brackets may be coupled to the elongated member at vertically spaced positions. The support brackets and the elongated member provide a guide for a vertically movable tool actuator. Essentially, the tool actuator may slide vertically upwardly and downwardly relative to the elongated member as required. The upper end of the tool actuator may carry the tool or cutting tool required to produce the holes in the ceiling. Such a tool may be a drill, either an electrically driven drill or a pneumatic or hydraulically driven drill. Typically, the drill will be a conventional electric motor drill which can be securely attached to the uppermost end of the actuator to drive a drill bit into the concrete ceiling when the actuator is projected upwardly.

The tool actuator may comprise a foot lever pivotally mounted on the tool support and configured to move the tool upwardly when the foot lever is depressed.

There is provided, therefore, a portable or movable base which moves about the floor with a vertically upwardly extending guide member such as the above-described elongated member, and a vertically upwardly extending slide member movable on the guide member. The cutting tool, such as a motorized drill, may be placed at the top of the slide member to be moved against the concrete ceiling.

### BRIEF DESCRIPTION OF THE DRAWINGS

FIG. 1 is an elevation view of one embodiment of the means for producing a hole, showing a tool, a tool support, and a tool actuator for moving a tool and causing it to produce a hole;

FIG. 2 is top view of the means for producing a hole of FIG. 1, showing four legs and a lever configured to move the tool and cause it to produce a hole; and

FIG. 3 is a cross-sectional view of the tool actuator 16 (foot lever) of FIG. 2, taken along the line A--A.

### DETAILED DESCRIPTION

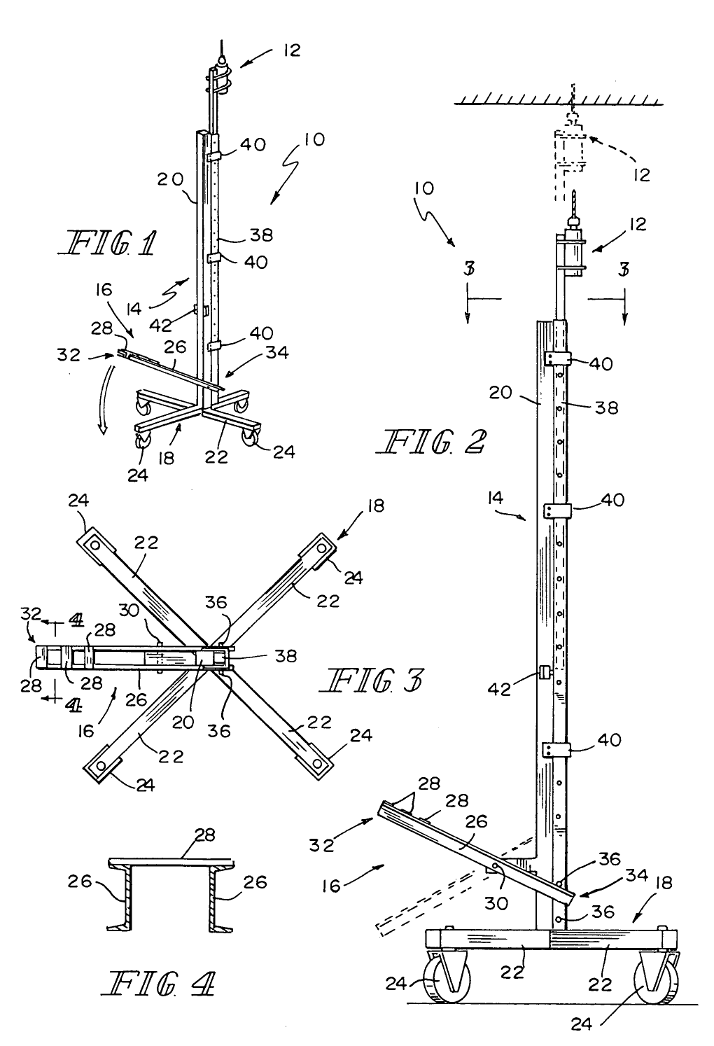

A means 10 for producing a hole is disclosed, the means comprising a tool 12, a tool support 14, and a tool actuator 16, as can be seen in FIG. 1. Tool 12 is illustratively a drill, but can be any other device know in the art for creating a hole, for example, tool 12 could be an awl, a hole punch, or a similar device configured for producing a hole. For the application of drilling holes in a concrete ceiling, of course, an electric drill motor with a chuck or other tool holder holding and driving a concrete drill bit will be suitable.

Tool support 14 is illustratively a base 18 having a vertically extending member 20 extending upwardly from a central portion of the base 18, as can be seen in FIG. 1. FIG. 2 shows a top view wherein base 18 illustratively comprises four legs 22 having castor wheels 24 mounted on the outward-most portions of legs 22. However, it should be understood that other configurations for base 18 are within the scope of the disclosure, for example, base 18 could comprise a solid platform, a stand, or any other support mechanism suitable for holding tool 12 and tool actuator 16 in a position that tool 12 can produce a hole. For drilling a multitude of holes in a concrete ceiling, however, it will be appreciated that ease of movement of the base 18 about the floor is important. The cross legs 22 with the central portion will be helpful in locating the base above intersections of chalk lines on the floor.

Tool actuator 16, as shown in FIG. 1 and in cross-sectional view in FIG. 3, illustratively comprises a foot lever constructed of two metal beams 26 aligned in parallel relationship, to beams 26 having a plurality of plates 28 mounted on a top surface of beams 26. Tool actuator 16 is illustratively a foot lever having a fulcrum point 30, such that depression of foot lever at outermost end 32 causes the foot lever (tool actuator 16) to pivot about fulcrum point 30, driving lift end 34 of the foot lever upwardly.

As lift end 34 of the foot lever is driven upwardly, lift end 34 engages pins 36, which illustratively extend from square tube 38. Such engagement causes tube 38 to move with the foot lever, and resultantly causes tool 12 to move into and out of hole-producing positions.

Square tube 38 is illustratively a 1 1/4 square inch sliding steel tube, the tube 38 sliding vertically relative to vertically extending member 20. Tube 38 is held adjacent vertically extending member 20 with brackets 40. Additionally, a tool cord bracket 42 is mounted on vertically extending member 20 for holding the power cord of tool 12, if applicable. The illustrative upwardly extending member 20 with its brackets 40 comprise a guide for the tube 38 which is a slide. While a guide-slide construction for moving a tool upwardly is relatively easy to construct and economical, it will be appreciated that any type of telescoping construction will suffice. The tube 38 may be sleeved over or sleeved within the upstanding member 20 to provide for relative vertical movement of the tool supported by the upper end of the tube 38.

Although the illustrative embodiment of tool actuator 16 is a foot lever, it should be understood that other means for driving tool 12 upwardly are within the scope of the disclosure. For example, pneumatic means, hydraulic means, a motor, a hand lever, or the like may be used to actuate tool 12 and cause it to produce a hole.

What is claimed is:

1. An apparatus for producing a plurality of holes in a downwardly facing surface such as a ceiling, the apperature comprising
a tool configured for producing a hole in the downwardly facing surface,
a tool support configured to support said tool above a floor, and
a tool actuator configured to vertically move the tool relative to the tool support such that the tool can be placed in hole-producing position relative to the surface.

2. The apparatus of claim 1, wherein the tool is one selected from the group including a drill, an awl, and a punch.

3. The apparatus of claim 1, wherein the tool support comprises a base having an elongated member extending vertically therefrom.

4. The apparatus of claim 3, wherein the base has castor wheels attached thereto for facilitating movement of the base relative to the floor.

5. The apparatus of claim 3, wherein the base comprises four legs.

6. The apparatus of claim 3, wherein the elongated member extends from a central portion of the base.

7. The apparatus of claim 3, wherein the elongated member is a square steel tube.

8. The apparatus of claim 3, wherein support brackets are coupled to the elongated member, the support brackets supporting the tool actuator for movement relative to the elongated member.

9. The apparatus of claim 1, wherein the tool actuator comprises a foot lever pivotably mounted on the tool support, the foot lever being configured to move the tool upwardly when the foot lever is depressed.

10. The apparatus of claim 1, wherein the tool actuator is one selected from the group comprising a pneumatic actuator, a hydraulic actuator, and a motorized actuator.

11. A device for drilling a multitude of holes in a ceiling, the device comprising:
means for producing an aperture in the ceiling, and
means for vertically moving the aperture-producing means into and out of aperture-producing positions at points in the ceiling.

12. The device of claim 11, wherein the aperture producing means is one selected from the group consisting of a drill, an awl, and a hole punch.

13. The device of claim 11, wherein the vertically moving means comprises one selected from the group consisting of a foot lever, a hand lever, a pneumatic actuator, and a hydraulic actuator.

14. The aperture of claim 11, further comprising a support base coupled to the vertically moving means, the support base supporting the vertically moving means on a floor and permitting movement of the vertically moving means relative to the support base.

15. A method for drilling a plurality of holes in a ceiling structure comprising
laying out a grid on the floor below the ceiling with intersecting grid lines on the floor corresponding to locations of holes in the ceiling,
providing a drill apparatus comprising a base movable about on the floor to locate over such intersecting grid lines with a drill movable vertically upwardly toward the ceiling and with an actuator for driving the drill upwardly, and
locating the drill over the intersecting grid lines and moving the drill upwardly to drill a hole in the ceiling.

16. The method of claim 15, wherein the actuator comprises one selected from the group comprising a foot lever, a hand lever, a pneumatic actuator, and a hydraulic actuator.

18. The method of claim 15, wherein the base comprises an elongated member extending vertically therefrom to support the drill apparatus.
